(19) United States
(12) Patent Application Publication
(10) Pub. No.: US 2013/0143019 A1
(43) Pub. Date: Jun. 6, 2013

(54) METHOD OF MAKING COILED-FILAMENT NONWOVEN WEB AND ARTICLES

(71) Applicants: Leigh E. Wood, Woodbury, MN (US); Lori-Ann S. Prioleau, St. Paul, MN (US); Thomas R. LaLiberte, Inver Grove Heights, MN (US)

(72) Inventors: Leigh E. Wood, Woodbury, MN (US); Lori-Ann S. Prioleau, St. Paul, MN (US); Thomas R. LaLiberte, Inver Grove Heights, MN (US)

(73) Assignee: 3M Innovative Properties Company

(21) Appl. No.: 13/308,962

(22) Filed: Dec. 1, 2011

(51) Int. Cl. D04H 13/00; B32B 5/00; B32B 5/02; B29C 55/02

(52) U.S. Cl. 428/219; 264/291; 442/335; 428/220; 428/222

(57) ABSTRACT

Presently described are methods of making nonwoven webs, nonwoven web articles, assembled intermediate articles comprising such nonwoven webs in combination with another substrate, and articles comprising the nonwoven webs or intermediates. The method comprises providing a first thermoplastic nonwoven web comprising a plurality of coiled filaments wherein the coiled filaments have an average diameter of at least 50 microns and are interengaged with intermittent bonds, and stretching the web. The thermoplastic nonwoven web comprises a plurality of stretched coiled filaments having an average diameter of at least 50 microns interengaged with intermittent bonds.

### BACKGROUND

Various methods of making nonwoven webs and nonwoven webs suitable for use in absorbent articles have been described. See for example U.S. Pat. No. 6,762,139; U.S. Pat. No. 4,351,683; U.S. Pat. No. 5,700,254; and US2006/0206073.

### SUMMARY

Although various nonwoven webs and methods of making have been described, industry would find advantage in new methods and nonwoven webs, such as those suitable for use as a fluid transport component of an (e.g. disposable) absorbent article.

In one embodiment, a process of making a nonwoven web is described. The method comprises providing a first thermoplastic nonwoven web comprising a plurality of coiled filaments wherein the coiled filaments have an average diameter of at least 50 microns and are interengaged with intermittent bonds, and stretching the web. In one embodiment, the stretching of the web breaks a portion of the bonds. In another embodiment, the thermoplastic nonwoven web has a lower basis weight after stretching.

Also described are thermoplastic webs prepared by the process described herein. In one embodiment, a thermoplastic nonwoven web is described comprising a plurality of stretched coiled filaments having an average diameter of at least 50 microns interengaged with intermittent bonds.

Also described is an assembled intermediate comprising a thermoplastic nonwoven web, as described herein, in combination with another substrate, such as an absorbent material or a carrier substrate.

Also described are absorbent articles, comprising a thermoplastic nonwoven web, as described herein, proximate an absorbent material, with the proviso that the absorbent article is not a personal hygiene article. The absorbent article may be suitable for use for spill containment or medical uses, such as wound dressings.

### BRIEF DESCRIPTION OF THE DRAWINGS

FIG. 1 is a schematic of a method of producing a stretched coiled-filament web;

FIG. 2 is a schematic of an embodiment of an apparatus that can be used to make coiled-filament webs useful for the initial (precursor) web for the method of FIG. 1;

FIG. 3 is a microphotograph of an unstretched coiled-filament web;

FIG. 4 is a microphotograph of an embodied stretched coiled-filament web;

FIG. 5 is a microphotograph of coiled-filament comprising a broken bond;

FIGS. 6 and 7 are microphotographs of embodied stretched coiled-filament webs;

FIG. 8 is a schematic of an embodiment of an apparatus that can optionally be used to further fabricate a coiled-filament web into assembled intermediates articles;

FIG. 9 is a microphotograph of an illustrative unstretched coiled-filament web;

FIG. 10 is a microphotograph of an illustrative stretched and relaxed coiled-filament web;

### DETAILED DESCRIPTION

Presently described are methods of making nonwoven webs, nonwoven web articles, and assembled intermediate articles comprising such nonwoven webs in combination with another substrate. The assembled intermediate may be suitable for use in personal hygiene articles or other articles. Also described are absorbent articles suitable for use for spill containment or medical uses, such as wound dressings, comprising the nonwoven web proximate an absorbent material. Such absorbent articles are not personal hygiene articles, such as adult incontinent products, sanitary napkins, and disposable diapers.

In one embodiment, a process of making a nonwoven web is described comprising the steps of providing a first thermoplastic nonwoven web comprising a plurality of coiled filaments and stretching the web, thereby forming a stretched web. The stretched web is typically further processed in order to maintain the web in at least a partially stretched configuration, such as by annealing and/or bonding the web to a substrate.

As used herein, the phrase “first thermoplastic nonwoven web” will be used herein interchangeably with the phrases “first nonwoven web”, “unstretched web”, “precursor web”, or “initial web”.

The filaments of the first thermoplastic nonwoven web and stretched web are formed from and thus comprise a thermoplastic polymer. Examples of suitable thermoplastic polymers that can be used to form the filaments or components thereof include polymers selected from the following classes: polyolefins, such as polyethylenes, polypropylenes, polybutylenes, blends of two or more of such polyolefins, and copolymers of ethylene and/or propylene with one another and/or with small amounts of polymerizable, higher, alpha olefins, such as pentene, methylpentene, hexane, or octane; halogenated polyolefins, such as chlorinated polyethylene, poly(vinylidene fluoride), poly (vinylidene chloride), and plasticized poly(vinyl chloride); copolyester-ether elastomers of cyclohexane dimethanol, tetramethylene glycol, and terephthalic acid; copolyester elastomers such as block copolymers of polybutylene terephthalate and long chain polyester glycols; polyethers, such as polyphenyleneoxide; polyamides, such as poly(hexamethylenedipamide), e.g., nylon 6 and nylon 6,6; nylon elastomers such as nylon 11, nylon 12, nylon 6,10 and polyether block polyamides; polyurethanes; copolymers of ethylene, or ethylene and propylene, with (meth)acrylic acid or with esters of lower alkanols and ethylenically-unsaturated carboxylic acids, such as copolymers of ethylene with (meth) acrylic acid, vinyl acetate, methyl acrylate, or ethyl acrylate; ionomers, such as ethylene-methacrylic acid copolymer stabilized with zinc, lithium, or sodium counterions; acrylonitrile polymers, such as acrylonitrile-butadiene-styrene copolymers; acrylic copolymers; chemically-modified polyolefins, such as maleic anhydride- or acrylic acid-grafted homo- or co-polymers of olefins and blends of two or more of such polymers, such as blends of polyethylene and poly(methyl acrylate), blends of ethylene-vinyl acetate copolymer and ethylene-methyl acrylate; and blends of polyethylene and/or polypropylene with poly(vinyl acetate). The foregoing polymers are normally solid, generally high molecular weight, and melt-extrudable such that they can be heated to form molten viscous liquids which can be pumped as streams to the extrusion die assembly and readily extruded therefrom under pressure as the filaments.

Preferably the coiled filaments are tough, durable, melt-bondable, thermoplastic, large-diameter filaments comprising synthetic organic plastic polymer or blends or multicomponent polymer filaments. In some embodiments, the filaments of the web comprise the same synthetic organic plastic material. In some embodiments, the filaments are formed from semicrystalline thermoplastic polymers, such as polyolefins. In other embodiments, a portion of the filaments comprise one type of synthetic organic plastic material and a portion of the filaments comprise a different type of synthetic organic plastic material. The filament can also comprise a plurality, e.g., 2 to 5, of components such as bicomponent filaments, such as a sheath-core or side-by-side filaments. The plastics forming the filaments can further have incorporated adjuvants or additives to enhance a property of or impart a property to the filament, such as stabilizers, processing aids, fillers, coloring pigments, crosslinking agents, foaming agents, and fire retardants.

Generally the filaments of both the first thermoplastic nonwoven web as well as the stretched and annealed web can have an average width, diameter, or cross-section dimension of at least 50 microns (i.e. 0.05 mm), or at least 100 microns, or at least 150 microns, or at least 200 microns. The average diameter may range up to 1000 microns (1 mm), yet is typically no greater than 800 microns, or 700 microns, or 600 microns, and in some embodiments no greater than 500 microns or 400 microns. The filament cross sectional dimension (and shape of the cross section) is preferably substantially, or essentially, uniform along the length of the filament, e.g., uniformly round. The surface of the filament is typically smooth. The filaments can be in the shape or form of fibers, strips, or other narrow and long shapes. Aggregations can be made up of a plurality of filaments with the same or different plastic compositions, geometric shapes, sizes, and/or diameters. The filaments are typically solid. The filaments can be circular or round in cross section or non-circular in cross section, e.g., lobal, elliptical, rectangular, triangular, and shapes with radial arms such as “x-shaped”. The filaments are preferably continuous in length, that is, of indefinite length in a common direction (e.g. machine direction).

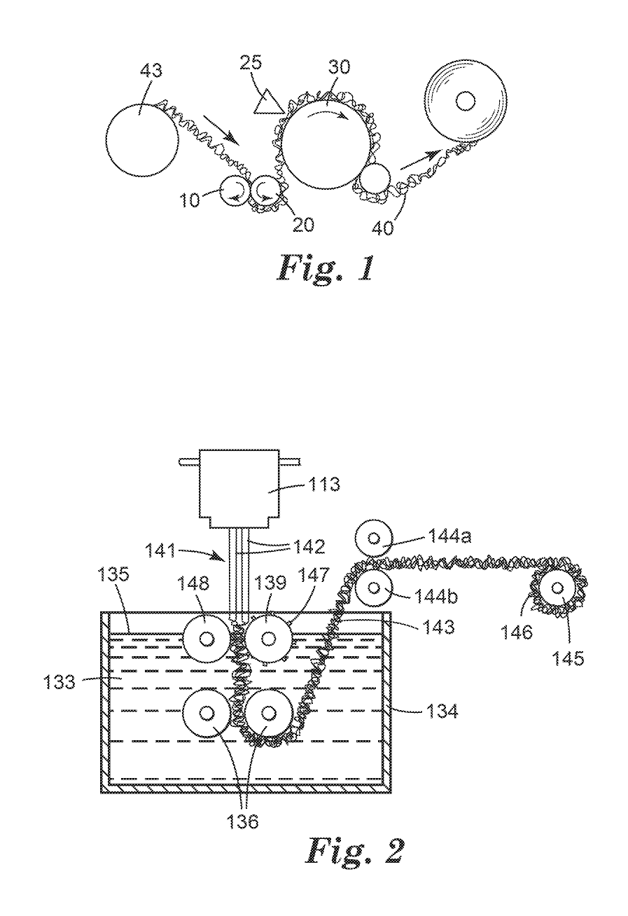

FIG. 1 depicts an illustrative method for producing a stretched and optionally annealed (e.g. coiled-filament) web. In this method, an initial precursor coiled-filament web 43 is provided, unwound between a pair of nip rollers 10 and 20 and drawn over a stretching roll 30. The stretching roll surface speed is greater than the speed of the web at the nip, which causes machine direction stretching of the web (at the location between the nip and stretching roll 30). The web is typically further processed to maintain the web in at least a partially stretched configuration. In one embodiment, warmed air 25 is directed at the web while it is held in the stretched state on the stretching roll. The warmed air anneals the stretched thermoplastic filaments of the web, thereby heat setting their stretched configuration. Alternatively, or in combination with annealing, the stretched web can be bonded to a substrate. Such further processing may be conducted during the same process used for stretching the web, such as depicted in FIG. 8. Alternatively, such further processing may be conducted during a subsequent process, such as when converting the web into an assembled intermediate or article. In this embodiment, the stretched web 40 may be wound onto a roll until such further processing.

With reference to FIG. 2, the initial precursor web, utilized as an input web for the method depicted in FIG. 1, is a coiled-filament web as can be made by processes described in the art (See for example U.S. Pat. Nos. 4,227,350; 4,351,683; 3,691,004; and 6,762,139; incorporated herein by reference).

The filaments are melt-extruded as a bundle or group of free-falling, closely spaced, generally parallel, discrete, continuous, filaments of hot, tacky, deformable, viscous polymer melts, the hot filaments are then convoluted (e.g. coiled) and cooled, or quenched, to a generally non-tacky or non-adhesive solid state. The hot filaments can be cooled by contact with a cooling means or medium, such as a liquid quench bath, e.g., a body of water. The web can then be advanced or conveyed through the bath and withdrawn therefrom. The web is convoluted (e.g. coiled) into discrete continuous filaments as the filaments are conveyed through the quench bath at a take-away speed which is less than the speed of the filaments entering the quench bath. This permits the falling, molten, still deformable filaments to convolute (e.g. coil into an essentially helical shape) adjacent the surface of the quench bath as described in U.S. Pat. No. 4,227,350. The use of a surfactant (for example, as described in said U.S. Pat. No. 3,837,988) in the quench bath may be desirable to aid coil formation.

In one embodiment, the first thermoplastic nonwoven webs are made with an extruder die assembly 113 that extrudes downwardly a plurality or bundle 141 of hot, continuous, large-diameter filaments 142, that fall freely in the quiescent ambient air into tank 134. The bundle 141 can be aligned so that some of the hot, viscous filaments 142 are permitted to make glancing contact with the outer surface of a guide roll 139. The roll 139 is optionally provided with spaced-apart guide pins or pegs 147, or some other type of guide, such as a stationery plate, to guide the hot, viscous filaments as they move, toward the surface 135 of a body or bath 133 of quench liquid, such as water, in tank 134. The surface of the quench liquid is disposed a suitable distance below the lower face of the extruder die assembly of 113 so as to achieve the desired diameter of the filaments as they enter the bath. The guide roll 139 can be set to cause glancing contact with the filaments 142, as described in said U.S. Pat. No. 4,351,683, which description is incorporated herein by reference. As the hot, viscous filaments 142 fall in the ambient air, they begin to cool from the extruding temperature (which can range, for example, from 150° C. to 400° C.). The extrusion temperature is typically sufficiently higher than the melt temperature such that the filaments coil. The guide roll 139 (as well as optional roll 148 and rolls downstream, e.g. 136, 144a, 144b and 145) can be set to rotate at a predetermined speed or rate such that the rate of lineal movement of the filaments 142 as they enter the body 133 of quench liquid is slower than the rate of linear movement of the hot, viscous filaments upstream of the guide roll(s). Since the take-away speed of the formed web 143 is slower than the speed of the hot filaments entering the quench bath 133, and the filaments 142 are still in a sufficiently viscous, deformable, or molten state, the filaments entangle or aggregate themselves by coiling, undulating, or oscillating just above the surface 135 of the quench liquid 133 into which they enter and can further cool, e.g., to about 50° C., quickly enough so that their shape does not deform, and solidify or rigidify just below the surface 135. A degree of resistance is imparted to the flow or free fall of the hot, viscous filaments 142 about the surface 135 by the already quenched, aggregated filaments in the quench bath 133 (quench liquid and quench bah are both referred to as 133) which causes the still deformable filaments entering the quench bath to coil, oscillate, or undulate just above the surface of the bath. This motion establishes irregular or random periodic contact between the still-hot filaments, resulting in spot- or tack-melt-bonding of contiguous surfaces of the filaments at their points of contact or intersection. Consequently, the filaments 142 assume a coiled, looped, sinuous or undulating configuration and become entangled or inter-engaged. The filaments 142 upon entering the quench liquid 133 and passing adjacent immersed guide roll 139 form an integrated web 143 of intermittently (e.g. spot- or tack-bonded) solidified filaments.

The web 143 can be conveyed and withdrawn from the tank 134 by means of pinch rolls 144a and 144b and wound by roll 145 to form a winding 146 of the web.

The contact surface(s) used may be in motion, as for example the surface of a rotating cylindrical drum as described in said U.S. Pat. No. 4,351,683, so as to collect the newly forming web and help convey it into and/or through the quench bath. The contact surfaces may alternatively be stationary, for example, a plate, such as described U.S. Pat. No. 3,691,004. The unified web thus formed comprises overlapping or entangled loops or coils of filaments and has sufficient structural integrity to allow the web to be conveyed, transported, or otherwise handled.

In one embodiment, the method of making the initial precursor coiled-filament web comprises the steps of simultaneously (or cojointly) melt-extruding thermoplastic polymers through a plurality-of extruder die openings or orifices, in the form of a plurality of discrete and separate hot, tacky molten filaments, entangling the filaments into the form of a web, cooling them, for example, in a water quench bath, and recovering the resulting non-tacky, solidified filaments as a web of such filaments. The diameter of the die openings can vary depending on the desired filament diameter. Since the filaments draw to some extent while free-falling, the extruder die openings are typically larger than the final filament diameter. For coiled-filament webs having a (cross-web) width of about 10 cm, the number of extruder die openings may be relatively small (e.g. 50 to 200). However, for larger (cross-web) width webs the number of extruder die openings is typically at least 300, 400, or 500 and typically no greater than 3000. In some embodiments, the number of extruder die openings is at least 20, 25, or 30 openings per linear inch of die.

This process produces a web wherein each filament is coiled and undulated throughout its length. The ratio of the actual filament length (i.e. uncoiled in machine direction) to the coiled filament length is typically at least 2:1 or 3:1 and typically no greater than 8:1. In some embodiments, the ratio of the actual filament length (i.e. uncoiled in machine direction) to the coiled filament length is no greater than 7:1, or 6:1, or 5:1. This ratio generally corresponds to the maximum stretch ratio. This ratio is typically constant with unchanged process conditions. Thus, although webs of various ratios can be made, a single web can typically be characterized by a ratio having a small range of actual filament length to coiled filament length. The undulations of each filament are typically irregular. However, it is possible to adjust the process to produce a regular helically coiled filament. Irregular filament undulation can be characterized by random looping, kinking, or bending of the filaments throughout the web in a pattern defined generally by the openings of extruder die. Typically more than one row of filaments are extruded to produce a web having layers of coiled and undulated filaments, each layer representing a tow of extruded filaments. Each layer can be discernible in the web, sometimes with great difficulty. The adjacent filaments between layers are typically bonded together where the filaments contact one another, thereby forming intermittent melt bonds.

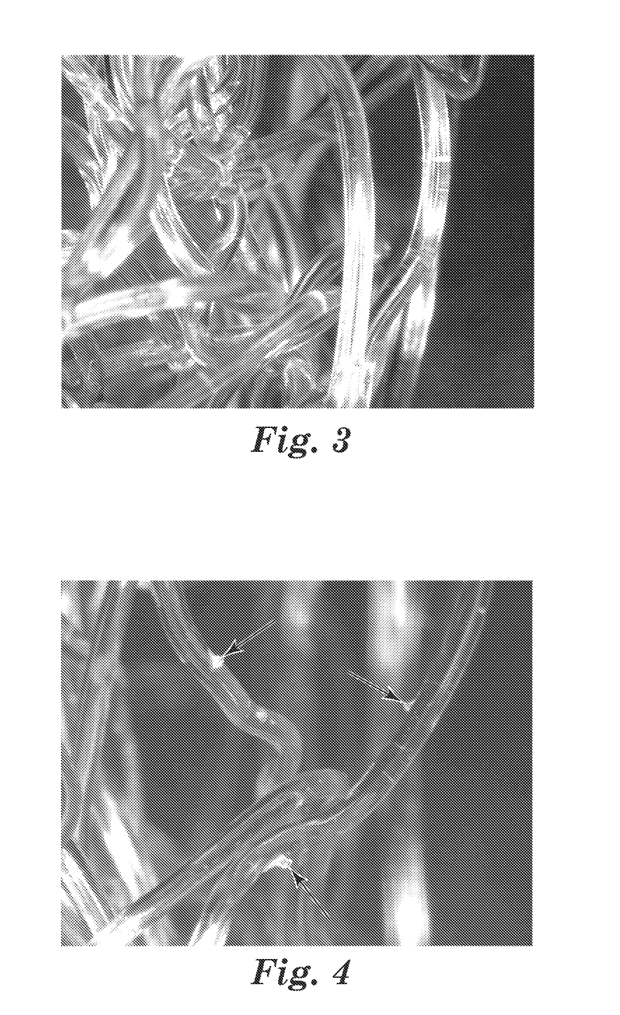

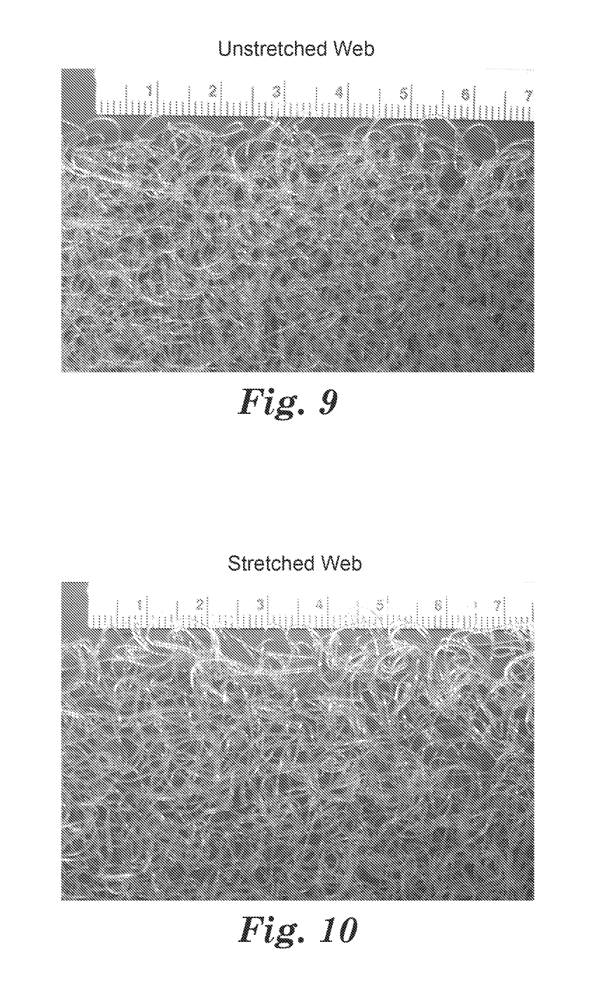

With reference to FIGS. 3 and 9, the first thermoplastic nonwoven web, as well as the stretched coiled-filament web is preferably a three dimensional network of random large diameter thermoplastic filaments. The filaments are randomly coiled or the like and generally can be continuous in one direction, i.e. machine direction.

The filaments form an open network of macropores; which macropores are defined by the nonlinear coiled filaments. The coiled-filament web is characterized as having open cells. The cells are random in size and orientation through the length and depth of the web. The cell structures are generally formed of substantially nonlinear filaments that randomly intersect. The filaments are generally nonlinear between their points of contact or bonding. In some embodiments, the stretched web generally has a larger pore size than the unstretched web precursor, due to stretching of the filaments and/or breaking of a portion of the intermittent bonds during stretching, such as evident by comparing FIGS. 9 and 10. The web generally has a high void volume, e.g., 40 to 99%, preferably 80% to 99%.

The web is typically a substantially planar web wherein the pores or “open spaces” are uniformly distributed throughout the thickness of the web.

The filaments of both the initial precursor web as well as the stretched web are preferably melt-bonded, which means that a plurality or aggregation of such filaments as an open, non-woven web, are bonded together at their points of contact or intersection to form a self supporting bonded structure by either heating the filaments sufficiently, to melt or soften a portion of the filaments, or by use of the latent heat of the filaments as extruded. The filaments form lofty webs of interengaged, intertwined, interlocked, or entangled filaments. The filaments are generally helical, spiral, looped, coiled, curly, sinuous or otherwise convoluted and extend from one end of the web to an opposite end of the web.

The (e.g. rows of) coiled filaments are continuous in a direction, i.e. the machine direction of the fabrication of the initial precursor web. The web is typically stretched substantially parallel to the direction the coiled filaments are continuous. By substantially parallel it is meant that the web can be stretched exactly parallel or a deviation from parallel. The deviation from parallel is less than 45 degrees and typically less than 30, 20, 10, or 5 degrees to maximize the benefits obtained by stretching the web parallel to the direction the coiled filaments are continuous. The web is generally stretched at least 2, 2.5 or 3 times the length of the initial web length (i.e. 100%, 150%, or 200%). The web is stretched to a distance no greater than the distance to uncoil the filaments, thereby providing substantially linear parallel filaments when stretched. The upper limit is dependent upon the extent of coiling (i.e. the ratio of actual filament length to coiled filament length). In typical embodiments, the web is stretched no greater than 6, 5 or 4 times the initial web length (i.e. 500%, 400%, or 300%).

In some embodiments, the method of producing the web comprises annealing and cooling the stretched web, in order that the stretched configuration of the web is maintained. As depicted in FIG. 1, the stretched web can be annealed and cooled while being maintained in the stretched state. However, for embodiments wherein the stretched web is further fabricated into an assembled intermediate or article such as by bonding the stretched web to another substrate, the annealing step may be optional.

In some embodiments, the stretched web is at least partially relaxed prior to annealing and cooling the stretched web. The relaxed web may be restretched (e.g. about 1-3 times the initial length of the unstretched precursor web). In this embodiment, the restretched web can be annealed and cooled while being maintained in the restretched state.

The stretched web may comprise one or more attributes that are characteristic of being stretched, such as broken bonds, filaments comprising oriented portions, filaments comprising portions of reduced filament diameter, and combinations thereof.

In some embodiments, the web is stretched at a temperature below the softening point of the bonds (e.g. melt-bonds). In doing so, the stretching of the web breaks a portion of the intermittent bonds present between continuous filaments (e.g. in cross-web direction). Thus, the stretched web comprises broken bonds. However, such stretching typically breaks few or no filaments in the machine direction. Hence, the filaments remain continuous during and after stretching, thus maintaining sufficient mechanical integrity of the web.

The stretched coiled-filament webs typically exhibit microscopic evidence that prior filament-to-filament bonding points have been broken. The microscopic evidence includes but is not limited to the presence of barbs, thorns, or other protrusion on the filaments, such as depicted in FIGS. 4 and 5. The extent of broken bonds can vary. Although, it is difficult to quantify the total number of broken bonds throughout the thickness of the web, a portion of the broken bonds are readily evident upon microscopy inspection of a single face of the stretched web. In some embodiments, the stretched web may comprise at least 1, 2, or 3 broken bonds per 1 cm² area. Typically, the distribution of the broken bonds is uniformly distributed throughout a single face or the entirety of the stretched web.

Preferably, the number of broken bonds per area is substantial enough such that one or more properties of the web have been altered relative to the unstretched web. For example, the filaments of the initial unstretched precursor web are typically sufficiently self-bonded such that the web does not substantially elongate in any direction (e.g. machine direction or cross-web direction) without breaking the intermittent bonds between coiled filaments of the web. In contrast, since a substantial portion of the intermittent bonds of the stretched web typically have already been broken, the stretched web can be elongated at least 25% in a direction substantially parallel to the direction the filaments are continuous without breaking (additional) bonds. The extent the stretched web can be elongated without breaking additional bonds relates to the extent of broken bonds in the stretched web. In some embodiments the stretched web can be elongated at least 50%, 75%, or 100% in a direction substantially parallel to the direction the filaments are continuous without breaking bonds. In other embodiments, the stretched web can be elongated at least 125%, 150%, 175%, or 200% in a direction substantially parallel to the direction the filaments are continuous without breaking bonds.

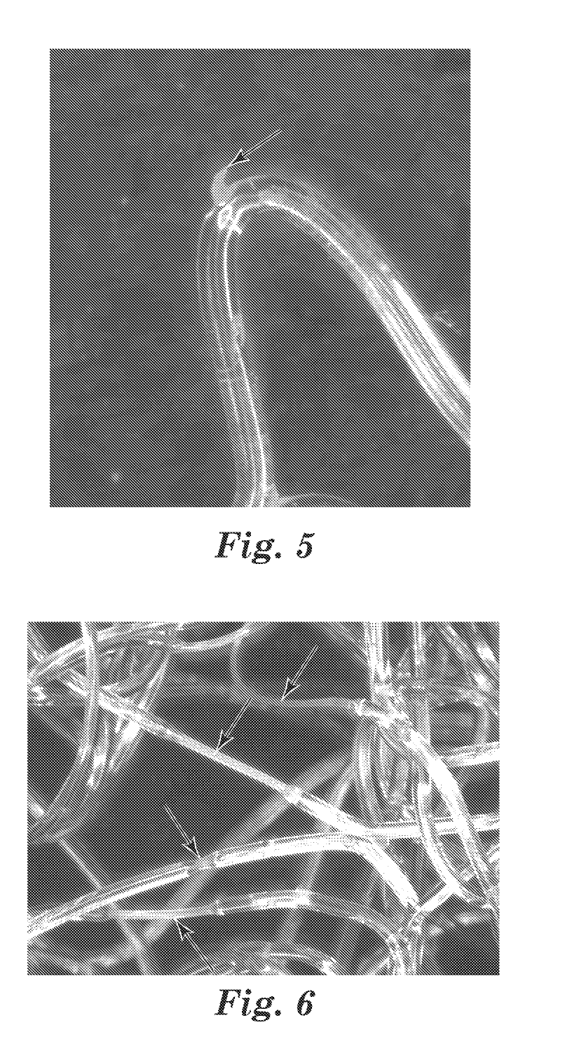

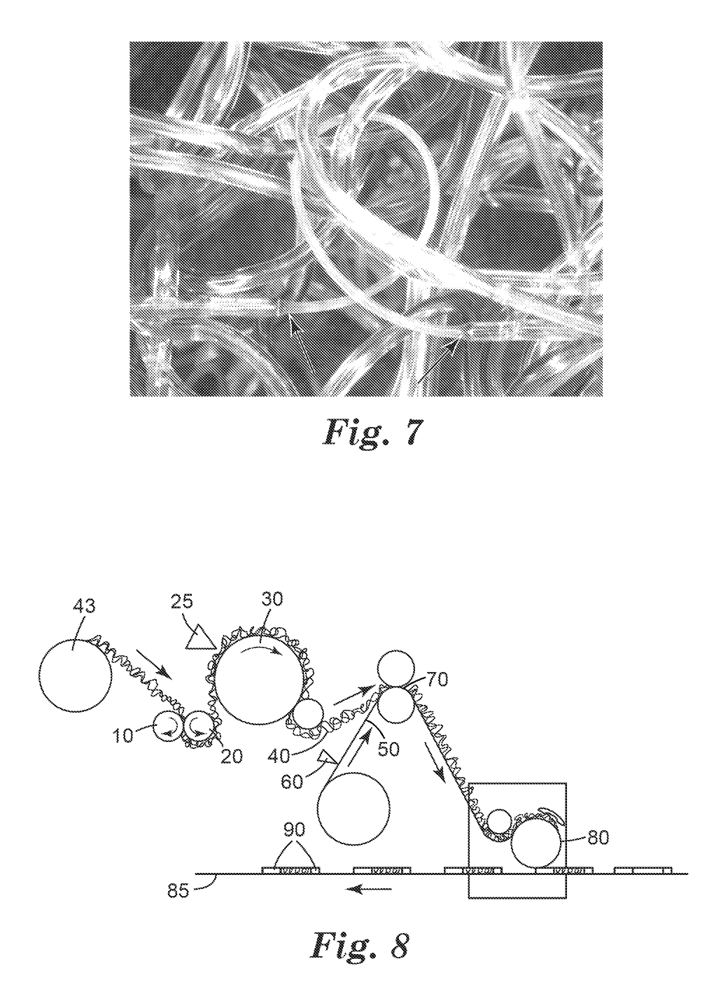

Alternatively, or in addition to the presence of broken bonds, the stretched web may comprise filaments comprising oriented portions and/or filaments comprising portions of reduced filament diameter. When the web is stretched at a temperature greater than the softening point of the filament material, but less than the melting point, oriented filament portions and/or filaments comprising portions of reduced filament diameter may be evident in the absence of broken bonds. Whereas the unstretched web typically comprises filaments of about the same filament diameter, as depicted in FIG. 3, the stretched web may comprise filaments wherein a portion of the filament has a substantially smaller diameter. For example, as depicted in FIGS. 5 and 6, the stretched web may comprise filaments wherein a portion of the filament has a diameter about 25% to 70% less than the diameter of the filament adjacent the (e.g. stretched) filament portion. Since the stretched filaments portions having a smaller diameter typically only occupy a relatively small portion of the totality of filaments, the average filament diameter is typically substantially the same or only slightly less than the average filament diameter of the stretched or unstretched web. In some embodiments, the portions of the filaments having a smaller diameter have the same transluscent appearance as the adjacent portion having a greater filament diameter. In other embodiments, the smaller diameter portions have a higher haze or less transparency due to crystalline phases of the thermoplastic materials of the filament becoming oriented during stretching.

In some favored embodiments, the stretched and relaxed web has a length greater than the initial precursor web. In some embodiments, the (cross direction) width of the web is at least 90% of the initial web, i.e. prior to stretching. Further, the thickness of the stretched web is typically greater than or equal to the unstretched web. These embodiments are amenable to providing a web having a lower basis weight and/or lower density. Although, the initial precursor coiled-filament web has a greater density, this same mass of material is distributed over a greater volume (e.g. greater length and/or thickness) after stretching. This is particularly advantageous when the desired web density is less than can be uniformly and/or efficiently produced by the process of FIG. 2.

In some embodiments, the initial basis weight of the first thermoplastic nonwoven (unstretched) web is 300 gsm to 800 gsm. However, the stretched web and optionally annealed web may decrease in basis weight by 15% to 75% of the initial basis weight of the first thermoplastic nonwoven web. In some embodiments, the stretched web and optionally annealed web decreases in basis weight by at least 20%, 25%, 30%, or 35% of the initial basis weight. Further, in some embodiments, the stretched and optionally annealed web decreases in basis weight by no greater than 70%, 65%, 60%, or 55%. In some embodiments, the stretched web and optionally annealed web has a basis weight of 200 gsm to 400 gsm. In some embodiments, the stretched web has a basis weight no greater than 350 gsm or 300 gsm.

The stretched, preferably relaxed, and optionally annealed web can have an increased thickness relative to the first thermoplastic nonwoven (unstretched) web. In some embodiments, the stretched web increases in thickness by at least 10%, 15%, or 20% of the initial thickness. Further, in some embodiments, the stretched web increases in thickness by no greater than 75%, 70%, 65%. In some embodiments, the stretched web has a thickness of at least 3 or 4 mm to about 20 mm. In some embodiments, the stretched web has a thickness is no greater than 15, 14, 13, 12, 11 or 10 mm.

The density of the first thermoplastic nonwoven (unstretched) web is typically at least about 0.04 g/cm³ and no greater than about 0.10 g/cm³. The stretched coiled-filament web can have a significantly lower density than the initial web. In some embodiments, the stretched web decreases in density by at least 10%, 15%, or 20% of the initial density of the first thermoplastic nonwoven web. Further, in some embodiments, the stretched web decreases in density by no greater than 80%, or 75% or 70%. In some embodiments, the stretched web has a density no greater than 0.10 g/cm³, 0.09 g/cm³, 0.08 g/cm³, 0.07 g/cm³, 0.06 g/cm³, 0.05 g/cm³, or 0.04 g/cm³. The stretched web may have a density of at least 0.01 g/cm³ or 0.02 g/cm³.

The stretched web can exhibit improved flexibility, which can be amenable to increased comfort when such web is utilized for example as a fluid transport component of an assembled intermediate or absorbent article. One property that is indicative to flexibility is work of compression; i.e. the total area under a stress-strain curve (between 0-90 kPa). Work of compression is an indicator of the energy absorbing properties of a material as calculated according to the formula described in US2008/0001431; incorporated herein by reference. In some embodiments, the stretched web decreases in work of compression by at least 10%, 15%, or 20% of the work of compression of the first thermoplastic nonwoven web. In some embodiments, the stretched web decreases in work of compression by at least 25%, 30%, 35% or 40% of the initial work of compression of the first thermoplastic nonwoven web. Further, in some embodiments, the stretched web decreases in work of compression by no greater than 60% or 55%. The stretched web may exhibit a work of compression of no greater than 20 kJ/m³. In some embodiments, the stretched web exhibits a work of compression of no greater than 10 kJ/m³. The work of compression of the stretched web is typically at least 2 or 3 kJ/m³. In some embodiments, the work of compression is no greater than 9, or 8, or 7, or 6 kJ/m³.

Another property that is indicative of flexibility is drapability. As used herein drapability refers to the shortest distance from the bottom face of the web to an adjacent vertical structure as determined by the drapability test method described in the examples. Thus, the shorter the distance the more the web bends downwardly. In some embodiments, the stretched web has a drapability less than 75 mm, 70 mm, 65 mm, 60 mm, 55 mm, or 50 mm. In some embodiments, the drapability of the stretched web is less than 45 mm, 40 mm, 35 mm, or 30 mm. The drapability may be zero. In some embodiments, the drapability is at least 3 mm, 5 mm, or 10 mm.

The hysteresis properties of the stretched web can be different than the first thermoplastic nonwoven web. The load, particularly at 25% or 50% extension of the stretched web can be substantially less than the first thermoplastic web. The stretched web can exhibit a load that is at least 10%, 15%, 20%, or 25% less than the initial load of first thermoplastic nonwoven web. In some embodiments, the stretched web can exhibit a load that is at least 30%, 35%, 40%, or 45% less than the initial load of the first thermoplastic nonwoven web. In some embodiments, the stretched web can exhibit a load that is at least 50%, 55%, 60%, 65%, 70% or 80% less than the initial load of the first thermoplastic nonwoven web. In some embodiments, the first thermoplastic web exhibits a load of at least 20 newtons at 25% extension; whereas the stretched web exhibits a load of less than 15, or 14, or 13 newtons at 25% extension. In other embodiments, the first thermoplastic web exhibits a load of at least 15 newtons at 25% extension; whereas the stretched web exhibits a load of less than 10 or 5 newtons at 25% extension. In some embodiments, the stretched web exhibits a load of less than about 20, 15, or 10 newtons at 50% extension.

The first thermoplastic webs and stretched webs are typically non-wicking. For example, the nonwoven web may exhibit a vertical wicking of saline solution of no greater than 5, 4, 3, 2, or 1 mm. Such vertical wicking is a property of the web alone, in the absence of being proximate an absorbent material. Without intending to be bound by theory, it is surmised that the web is non-wicking due to the filaments being spaced too far apart to create capillary action. The non-wicking webs exemplified herein are generally prepared from a hydrophobic polymer such as a polyolefin. Further, such non-wicking webs are free of superabsorbent polymer.

The stretched nonwoven webs were found to provide fast fluid transport rates (as tested accordance to the test method described in the examples). Such fluid transport rate is also a property of the web alone, in the absence of being proximate an absorbent material. In some embodiments, the fluid transport rate was no greater than 10, 9, 8, 7, 6, 5, 4, or about 3 seconds with a weight of 4 kg. In some embodiments, the fluid transport rate was no greater than 15, 14, 13, 12, 11, 10, 9, 8, 7, 6, or about 5 seconds with a weight of 12 kg. In some embodiments, the fluid transport rate was no greater than 20, 19, 18, 17, 16, 15, 14, 13, 12, 11, 10, 9, 8, or about 7 seconds with a weight of 24 kg.

The stretched nonwoven webs described herein are suitable for use as a fluid transport component of an assembled intermediate, such as suitable for use in a (e.g. disposable) absorbent personal hygiene article. Whereas a finished personal hygiene article typically comprises a fluid transport nonwoven web proximate an absorbent (e.g. core) material between a fluid pervious topsheet and fluid impervious backsheet, an assembled intermediate article lacks at least one requisite component of a finished absorbent article. For example, the assembled intermediate typically lacks a fluid impervious backsheet and/or a fluid pervious topsheet. Thus, the assembled intermediate may be a component of a finished personal hygiene article or other articles.

The assembled intermediate comprises the stretched web, as described herein, in combination with at least one other substrate. In some embodiments, the assembled intermediate comprises the stretched web proximate, but not bonded to another substrate. For example, the stretched web may be placed proximate an absorbent material forming an assembled intermediate during the manufacture of an absorbent article. In other embodiments, the assembled intermediate comprises the stretched web bonded to another substrate. For example, the stretched web may be bonded to a (e.g. liquid pervious) carrier substrate, such as a nonwoven or tissue, to facilitate handling of the web by conventional high speed manufacturing processing. In yet another embodiment, the stretched web alone or in combination with a proximate absorbent material may be coated with a (e.g. pressure sensitive) adhesive on at least one major surface that is covered by a release liner carrier substrate. During manufacture of an absorbent article, the release liner is removed and the adhesive is contacted with another component of an absorbent article, such as a liquid impervious backsheet. In yet another embodiment, the stretched web in combination with a proximate absorbent material may be bonded to a carrier substrate such as a nonwoven or film that may subsequently be cut into pieces for and incorporation into an absorbent article.

FIG. 8 depicts one illustrative method of a stretched and optionally annealed web being further fabricated into an assembled intermediate. With reference to FIG. 8, the stretched and optionally annealed coiled-filament web 40 may be conveyed to an apparatus 80 that cuts the web into discrete pieces and places them proximate an absorbent material 90. The assembled intermediate of the coiled-filament web proximate the absorbent material may be conveyed on a moving belt 85 that conveys the assembled intermediate to subsequent manufacturing operation. Alternatively, the assembled intermediate may be temporarily or permanently bonded to a carrier substrate provided on the belt. When bonded to a carrier substrate, such intermediate may be wound on a roll, to be utilized as a component of an absorbent article. The stretched and optionally annealed coiled-filament web may be bonded to another substrate, such as a liquid pervious substrate 50 (e.g. nonwoven, tissue, or fluid acquisition layer). This can be accomplished for example by applying an adhesive to the substrate 50 with an applicator 60 and laminating the adhesive applied substrate to the stretched and annealed coiled-filament web 40 in a laminating nip 70, as further depicted in FIG. 8. Alternatively or in combination with a liquid pervious substrate (e.g. nonwoven, tissue, or fluid acquisition layer) being applied to (the upper, topsheet-facing) major face of the web; a substrate may be bonded to the opposing (lower, backsheet-facing) major surface of the web. For example, the inclusion of a substrate, such as tissue, can aid in handling the web in subsequent operations without further stretching of the filament-coiled web. The inclusion of a substrate, such as tissue, can also aid in the web being cut into discrete pieces for inclusion into the finished composite absorbent constructions using a vacuum wheel type applicator, which is a common and known way of cutting and placing discrete pieces of material onto another material. In the absence of the tissue or other layer to reduce the porosity and air flow of the web, it may be difficult to handle the web using vacuum assisted cutting and placing operations. The web may be proximate the absorbent core in various arrangements, some of which are described in concurrently filed 67798US002; incorporated herein by reference.

When being bonded to another substrate, the stretched and optionally annealed coiled-filament web or more typically the other substrate can be coated with an adhesive or binder on all or a portion of its surface area. Examples of suitable emulsion, hot melt, curable, or solvent-based adhesives or binders or pressure sensitive adhesives include (meth)acrylate-based pressure sensitive adhesives, such as those described in U.S. Pat. No. Re 24,906(Ulrich), polyurethane adhesives, natural or synthetic rubber-based adhesives, epoxy adhesives, curable adhesives, phenolic adhesives, and the like.

The stretched nonwoven webs described herein are suitable for use as a fluid transport component of other absorbent articles, such as suitable for spill containment or medical uses, such as wound dressings. Such other absorbent articles may comprise all the requisite components of a finished (e.g. disposable) absorbent article. Hence, such other articles may comprise a fluid transport nonwoven web proximate an absorbent (e.g. core) material in combination with a fluid pervious topsheet and/or a fluid impervious backsheet.

The stretched coiled-filament webs were found to provide fast fluid (e.g. saline solution) uptake rates when proximate an absorbent material. By proximate it is meant that at least a portion of the coiled-filament web is in direct contact with the absorbent material or that a portion of the web is in fluid communication with the absorbent material, yet not in direct contact. When the nonwoven web is in fluid communication, but not in direct contact, one or more other fluid pervious substrates, such as a tissue layer, may be present between the nonwoven web and absorbent material. In some favored embodiments, the nonwoven web comprises a first major face and a second opposing major face substantially parallel to the first major face and a thickness in a direction orthogonal to the first and second major face. The thickness of nonwoven web defines lateral edges and the absorbent material is in contact with or in fluid communication with at least a portion of the lateral edge. In some embodiments, at least two opposing lateral edges of the nonwoven web are in contact with or in fluid communication with the absorbent material. The other two opposing edges may be fluid impervious by sealing such edges. In another embodiment, all the lateral edges of the nonwoven web are in contact with the absorbent material.

The absorbent (core) material is typically a highly absorbent material that comprises superabsorbent polymer. The absorbent material typically comprises a blend of cellulosic fibers and superabsorbent material. One illustrative absorbent material has a basis weight from about 100 g/m² to about 700 g/m² which has been air-laid as a bottom layer of pulp, a middle layer of pulp and superabsorbent polymer disposed in amongst the pulp, and a top layer containing at least some pulp. The absorbent material may have a density of 0.25 or 0.3 g/cc to about 0.4 g/cc.

The absorbent material typically comprises at least 5 or 10 wt-% and preferably at least 15, 20, 25 or 30 wt-% of superabsorbent polymer. The superabsorbent polymer is typically no greater than 60 wt-% of the absorbent material and in some embodiments, no greater than 55, 50, 45, or 40 wt-%. The absorbent material may have a basis weight of at least 150 to 200 g/m² and typically no greater than 300 or 350 g/m².

Various absorbent (core) materials and methods of making such have been described in the art. (See for example U.S. Pat. No. 4,610,678 and U.S. Pat. No. 6,896,669).

In some embodiments, the fluid uptake rate (as tested in accordance to the test method described in the examples) was no greater than 10, 9, 8, 7, 6, 5, or about 4 seconds with a weight of 4 kg. Notably commercially available products that were tested were found to have a fluid uptake rate of about 23-31 seconds with a weight of 4 kg. In some embodiments, the fluid uptake rate was no greater than 50, 40, 30, 20, and in some embodiments no greater than 15 seconds with a weight of 12 kg. Notably commercially available products that were tested were found to have a fluid uptake rate of about 98-102 seconds with a weight of 12 kg. In some embodiments, the fluid uptake rate was no greater than 50 or 40 seconds, and in some embodiments no greater than 35 or 30 seconds with a weight of 24 kg. Notably commercially available products that were tested were found to have a fluid uptake rate of about 102-182 seconds with a weight of 24 kg. Such fluid uptake performance can be achieved with a single fluid challenge (100 ml of 0.9% NaCl in water) or at least two (2-100 ml doses of 0.9% NaCl in water separated by a time interval of 2 minutes). Although the fluid uptake rate (as measured in accordance with the test method described in the examples) was measured on a finished personal hygiene article, the topsheet and backsheet are surmised to have little or no effect on the test results. Hence, the fluid uptake rate is surmised a property of an assembled intermediate of the stretched web proximate an absorbent material.

Another property that is indicative of the fluid transport properties is length of longitudinal fluid distribution (as tested in accordance to the test method described in the examples). In some embodiments, the length of longitudinal fluid distribution is at least 100, 110, 120, 130, 140 mm, and in some embodiments at least 150 or 160 mm with a weight of 4 kg. Notably commercially available products that were tested were found to have a length of longitudinal fluid distribution of 85 mm. In some embodiments, the length of longitudinal fluid distribution is at least 100, 125, 150, 160 mm, and in some embodiments at least 170, 180, 190, or 200 mm with a weight of 12 kg. Notably commercially available products that were tested were found to have a length of longitudinal fluid distribution of 78-85 mm. In some embodiments, the length of longitudinal fluid distribution is at least 125, 150, 160 mm, and in some embodiments at least 170 mm with a weight of 24 kg. Notably commercially available products that were tested were found to have a length of longitudinal fluid distribution of 95-100 mm.

The coiled-filament web, utilized as a fluid transport element of an absorbent component can have various shapes including symmetrical (having a point, line, or plane of symmetry) or unsymmetrical shapes. Coiled web shapes that are envisioned include but are not limited to circles, ovals, squares, rectangles, pentagons, hexagons, octagons, trapezoids, truncated pyramids, hourglasses, dumbbells, dog bones, etc. The edges and corners can be straight or rounded. The sides can be curved (convex or concave), tapered, flared, or angled. In addition, the coiled web can contain cut-out regions that create voids, cavities, depressions, channels, or grooves. In some embodiments, the shape of the coiled web is preferably rectangular. Regardless of the shape, a coiled-filament web fluid transport elements can generally be defined as having a first major face, a second opposing major face substantially parallel to the first major face, and a thickness in a direction orthogonal to the first and second major face.

The stretched web may comprise various functional additives including for example, antimicrobial coatings, ion capturing coatings, desiccants, and odor control particles.

Whereas lower basis weight/lower density coiled-filament webscan be desirable for the fluid transport properties of the web, lower density webs are typically less desirable from a web manufacturing and shipping perspective. Thus in one embodiment, a higher density precursor web is manufactured and shipped and this precursor web is stretched and optionally annealed during the subsequent manufacture of an assembled intermediate or (e.g. disposable) absorbent article. Alternatively, the precursor web can be made and fabricated into a fluid transport component of an absorbent article by stretching and annealing in a single continuous process, e.g. by combining the processes depicted in FIGS. 1 and 2 or 8 into a single (e.g. continuous) process.

The invention is illustrated by the following non-limiting examples.

### Coiled Web Preparation

### Examples 1-10

### Unstretched Web

Coiled webs were prepared according to the method described in U.S. Pat. No. 6,762,139 (Strommen). A Haake model extruder (Thermo Electron Corporation, Newington, N.H.) with a one inch screw was used. The die temperature was set at 260-302° C. The cooling bath was a 100 gallon water bath maintained at 21-27° C. TRITON GR-5M surfactant (0.025%, Dow Chemical Company, Midland, Mich.) was added to the cooling bath. The basis weight of the coiled webs was controlled by individual adjustments to the resin throughput of the extruder and the line speed for withdrawing the web from the cooling bath. The screw speed of the extruder ranged from 5-100 rpm and the line speed for withdrawing the web from the cooling bath ranged from 5-15 meters/minute. The coiled webs of Examples 1-2 were prepared using ELITE-5815 polyethylene thermoplastic resin (Dow Chemical Company, Midland, Mich.). The coiled webs of Examples 3-6 were prepared using VERSIFY-4200 polypropylene thermoplastic resin (Dow Chemical Company, Midland, Mich.). The coiled web of Example 7 was prepared from a 1:1 weight ratio blend of ELITE-5815 and ENGAGE-8407 polyethylene resin (Dow Chemical Company, Midland, Mich.). The coiled webs of Examples 8-9 were prepared using DOW C700-35N polypropylene impact copolymer thermoplastic resin (Dow Chemical Company, Midland, Mich.). The coiled web of Example 10 was prepared using nylon 6 resin (commercially available as ULTRAMID Polyamide 6 from the BASF Corporation, Wyandotte, Mich.). For Examples 1-9, a 102 mm by 19 mm patterned extrusion die was used that contained 117 (760 micron in diameter) holes evenly spaced in five rows. The width of the coiled webs was 10 cm as measured in the cross direction (CD). The measured values of filament diameter (microns), web basis weight (gsm), web thickness, and web density are reported in Table 1 for Examples 1-10.

### Examples 11-21

### Stretched Web

The coiled-filament stretched webs of Examples 11-21 were prepared by providing an unstretched precursor web selected from Examples 1-10 and further processing of the precusor webs by a combination of hand stretching and annealing. A sample of coiled web measuring 30 cm in the machine direction (MD) and 10 cm in the cross direction (CD) was used. Two ink marks were made with each mark positioned 10 cm from the edge in the MD. The sample was grasped by hand at the marked positions and stretched in the MD until the two marks were either 30 or 40 cm apart (a 3:1 or 4:1 stretch ratio). During this hand stretching operation, numerous filament to filament bonds in the coiled web were broken. The tension was removed and the web was allowed to return to a relaxed state. In the relaxed state, the stretched portion of the web was significantly less than 40 cm, with lengths between the two ink marks measuring about 12-13 cm. The stretched section of the web was hand stretched a second time to a position where the ink marks were held 20-25 cm apart (approximate 2:1 stretch ratio). The sample was held in the stretched position, clamped to a piece of cardboard, and placed in a hot air oven set at 65° C. for 30-45 seconds. The stretched and annealed sample was removed from the oven, maintained at ambient temperature for 1 minute, and then released from the clamping apparatus to provide the final product.

The hand stretching method described above was used to prepare the stretched coiled webs of Examples 11-21. Examples 11-13 were prepared starting with Example 1, while Examples 14-16 were prepared starting with Example 7 and Examples 17-21 were prepared starting with Example 3. The starting coiled web was 6.2 mm thick for Example 1, 7.1 mm thick for Example 7, and 7.2 mm thick for Example 3. In Table 2, measured values are reported for the distance of the initial web stretch, the relaxed distance of stretched web material after the initial stretch, the distance of the second web stretch, and the relaxed distance of the stretched web material after the second stretch and annealing step. For Examples 10-20, data was collected from three replicates and the mean values are reported.

In Table 3, the measured values of web basis weight (gsm), web thickness (mm), and web density (g/cm³) are reported for Examples 11-21. For each of the three web properties, the difference between the value measured for the stretched web and the value measured for the unstretched precursor web was calculated. A calculation of the percent increase or decrease in the value was also done. The calculations are reported in Table 4 and show that stretching the coiled webs resulted in the formation of webs with increased thickness, decreased basis weight and decreased density.

TABLE 1
Unstretched Coiled Webs

| | Filament | | | |
|---|---|---|---|---|
| | Diameter | Web Basis | Web Thickness | Web Density |
| | (microns) | Weight (gsm) | (mm) | (g/cm³) |
| Example 1 | 357.6 | 541.3 | 6.2 | 0.087 |
| Example 2 | 400.3 | 366.7 | 4.7 | 0.078 |
| Example 3 | 374.7 | 480.8 | 7.2 | 0.067 |
| Example 4 | 495.4 | 561.8 | 12.9 | 0.043 |
| Example 5 | 701.9 | 705.8 | 11.4 | 0.062 |
| Example 6 | 736.1 | 531.7 | 7.9 | 0.067 |
| Example 7 | 347.7 | 422.4 | 7.1 | 0.059 |
| Example 8 | 501.5 | 514.9 | 9.5 | 0.054 |
| Example 9 | 496.0 | 473.6 | 5.6 | 0.084 |
| Example 10 | 292.5 | 400.5 | 12.6 | 0.032 |

TABLE 2
Data from the Process for Hand Stretching Coiled Webs

| | | | | Relaxed Dis- |
|---|---|---|---|---|
| | | Relaxed Dis- | | tance of Web |
| | Distance of | tance of Web | Distance of | After Second |
| Example | First Web | After First | Second Web | Stretch and |
| No. | Stretch (cm) | Stretch (cm) | Stretch (cm) | Annealing (cm) |
| Example 11 | 40 | 12.8 | 25 | 22.3 |
| Example 12 | 30 | 12.5 | 22 | 19.8 |
| Example 13 | 40 | 12.7 | 20 | 18.0 |
| Example 14 | 40 | 12.7 | 25 | 23.7 |
| Example 15 | 30 | 12.2 | 22 | 20.5 |
| Example 16 | 40 | 12.7 | 20 | 19.8 |
| Example 17 | 40 | 11.8 | 25 | 21.0 |
| Example 18 | 30 | 11.0 | 22 | 18.7 |
| Example 19 | 40 | 12.2 | 20 | 17.7 |
| Example 20 | 30 | 11.5 | not done | not done |
| Example 21 | 40 | 12.5 | not done | not done |

TABLE 3
Stretched Coiled Webs

| | Web Basis | Web Thickness | Web Density |
|---|---|---|---|
| | Weight (gsm) | (mm) | (g/cm³) |
| Example 11 | 294.0 | 7.8 | 0.038 |
| Example 12 | 226.0 | 9.4 | 0.024 |
| Example 13 | 287.8 | 10.0 | 0.029 |
| Example 14 | 222.7 | 8.6 | 0.026 |
| Example 15 | 267.0 | 8.1 | 0.033 |
| Example 16 | 255.3 | 10.0 | 0.025 |
| Example 17 | 257.7 | 8.5 | 0.030 |
| Example 18 | 304.8 | 8.5 | 0.035 |
| Example 19 | 305.9 | 9.1 | 0.034 |
| Example 20 | 463.8 | 8.3 | 0.056 |
| Example 21 | 417.8 | 9.1 | 0.046 |

TABLE 4
Calculations for Stretched Coiled Webs

| | Decrease in | Percent | Increase | Percent | Decrease | Percent |
|---|---|---|---|---|---|---|
| | Web Basis | Decrease in | in Web | Increase | in Web | Decrease |
| | Weight | Web Basis | Thickness | in Web | Density | in Web |
| | (gsm) | Weight | (mm) | Thickness | (g/cm³) | Density |
| Example 11 | 247.3 | 46% | 1.6 | 26% | 0.049 | 56% |
| Example 12 | 315.3 | 58% | 3.2 | 52% | 0.063 | 72% |
| Example 13 | 253.5 | 47% | 3.8 | 61% | 0.058 | 67% |
| Example 14 | 199.7 | 47% | 1.5 | 21% | 0.033 | 56% |
| Example 15 | 155.4 | 37% | 1.0 | 14% | 0.026 | 44% |
| Example 16 | 167.1 | 40% | 2.9 | 41% | 0.034 | 58% |
| Example 17 | 223.1 | 46% | 1.3 | 18% | 0.037 | 55% |
| Example 18 | 176.0 | 37% | 1.3 | 18% | 0.032 | 48% |
| Example 19 | 174.9 | 36% | 1.9 | 26% | 0.033 | 49% |
| Example 20 | 17.0 | 4% | 1.1 | 15% | 0.011 | 16% |
| Example 21 | 63.0 | 13% | 1.9 | 26% | 0.021 | 31% |

### Photomicrograph Examination of Webs

Photomicrographs of unstretched coiled webs (Examples 1 and 7) and stretched coiled webs (Examples 13 and 15) were taken using a Leica Model MZ16 stereomicroscope at a magnification of 7.1× (commercially available from Leica Microsystems, Wetzlar, Germany). The photomicrographs were examined for broken filament to filament bonds in the webs. The web sample was laid flat on the stage of the microscope and photomicrographs were taken from the top face of the web in five randomly selected regions of the web. All of the photomicrographs were of samples measuring 0.83 cm² in size (10.5 mm (MD) by 7.9 mm (CD)). Two individuals examined the photomicrographs and independently counted barbs. This resulted in a total of ten replicates for each sample. The individual values were averaged and the mean value for each coiled web example was determined. The results are reported in Table 5. In the test method, examination of the photomicrographs was limited to counting barbs that projected sideways from a filament. Barbs hidden behind a filament or projecting into or away from the camera were not clearly visible and consequently not counted. The actual number of barbs in the sample area was greater than the number determined by the test method.

TABLE 5

| | | Mean Number of Broken |
|---|---|---|
| | Type of Web | Bonds (n = 10) |
| Example 1 | unstretched | 0 |
| Example 13 | stretched | 3.9 |
| Example 7 | unstretched | 0.2 |
| Example 15 | stretched | 3.8 |

### Compressibility

The energy required to compress the coiled webs was measured. All testing was conducted at constant temperature (23° C.±2° C.) and relative humidity (50%±5%). All materials and equipment were equilibrated at these conditions for a minimum of 24 hours prior to testing. A universal constant rate of extension tensile testing instrument equipped with a computer for data recording and the required load ranges was used (Series 4200, 4500, or 5500 available from Instron Engineering Corporation, Canton, Mass.). The instrument crosshead speed was set to 200 mm/minute and the calibrated load cell used was rated for 500 N. The finished sample of coiled web was cut in a 3 inch diameter circle and the thickness was measured using a digital hand-held caliper. Three replicates of fresh materials were used for each sample and the data is reported as the average of the recorded values.

The Instron instrument was fitted with two compression platens (6 inch diameter) aligned in parallel with one attached to the lower jaw creating the base and one attached to the upper jaw creating the moving piston that applied the compressive force. The platens were brought into contact and the jaw gap measurement was set to zero on the instrument. The platens were then drawn apart to a distance equal to the sample thickness. The gauge length was reset to zero and then manually jogged a nominal distance further apart to allow for sample placement. The sample was placed on the lower platen and the top platen was returned to the zero position against the sample. The sample was then compressed with automatic recording of the compressibility (percent strain) at compressive stresses (kPa) of 1, 5, 10, 20, 40, 60, and 100 kPa. The area under the plotted stress-strain curve (between 0-90 kPa) was calculated and reported as the Work of Compression (WOC) in kilojoules/m³ (Tables 6 and 7).

The difference between the WOC value measured for each stretched web sample (Examples 11-13, 15, and 17-21) and the WOC measured for the corresponding unstretched precursor web was calculated. The percent decrease in WOC was also determined. The results are reported in Table 8. The data shows that stretching a coiled web resulted in a decrease in the WOC measurement.

TABLE 6
Compressibility Data for Unstretched Coiled Webs

| | Percent Strain (%) | | | | | | | |
|---|---|---|---|---|---|---|---|---|
| | at | at | at | at | at | at | At | |
| | 1 | 5 | 10 | 20 | 40 | 60 | 100 | WOC |
| Example | kPa | kPa | kPa | kPa | kPa | kPa | kPa | (kJ/m³) |
| Example 1 | 13.9 | 30.7 | 45.8 | 59.3 | 68.5 | 73.0 | 78.6 | 10.2 |
| Example 2 | 14.5 | 24.9 | 35.8 | 45.9 | 52.0 | 55.9 | 60.3 | 7.4 |
| Example 3 | 14.9 | 42.6 | 61.7 | 74.9 | 82.9 | 86.5 | 91.0 | 9.6 |
| Example 4 | 39.6 | 60.3 | 73.3 | 81.7 | 87.0 | 89.2 | 92.1 | 6.6 |
| Example 5 | 28.3 | 35.4 | 45.1 | 61.0 | 74.1 | 79.3 | 84.7 | 11.6 |
| Example 6 | 18.6 | 28.1 | 37.4 | 50.6 | 61.2 | 65.6 | 70.8 | 10.0 |
| Example 7 | 13.3 | 54.8 | 66.7 | 73.4 | 78.5 | 81.3 | 85.1 | 7.6 |
| Example 8 | 0.0 | 8.7 | 17.0 | 33.9 | 52.1 | 61.7 | 70.5 | 29.3 |
| Example 9 | 0.0 | 0.0 | 9.4 | 17.7 | 25.1 | 33.7 | 45.1 | 30.5 |
| Example 10 | 3.9 | 25.6 | 42.9 | 62.4 | 75.4 | 80.5 | 85.2 | 19.2 |

TABLE 7
Compressibility Data for Stretched Coiled Webs

| | Percent Strain (%) | | | | | | | |
|---|---|---|---|---|---|---|---|---|
| | at | at | at | at | at | at | at | |
| | 1 | 5 | 10 | 20 | 40 | 60 | 100 | WOC |
| Example | kPa | kPa | kPa | kPa | kPa | kPa | kPa | (kJ/m³) |
| Example 11 | 20.3 | 45.8 | 54.2 | 59.2 | 63.5 | 65.6 | 68.8 | 5.9 |
| Example 12 | 36.3 | 60.7 | 68.6 | 75.2 | 79.0 | 81.1 | 83.8 | 8.1 |
| Example 13 | 38.3 | 64.9 | 72.9 | 79.0 | 83.1 | 85.2 | 88.1 | 5.6 |
| Example 15 | 52.6 | 71.9 | 75.8 | 80.5 | 82.7 | 84.3 | 86.2 | 3.7 |
| Example 17 | 35.3 | 65.4 | 72.8 | 78.6 | 81.9 | 83.6 | 86.1 | 5.1 |
| Example 18 | 26.4 | 58.6 | 68.1 | 74.8 | 78.9 | 81.0 | 83.8 | 6.1 |
| Example 19 | 25.7 | 54.0 | 63.4 | 70.5 | 74.6 | 76.8 | 79.5 | 5.9 |
| Example 20 | 13.6 | 40.9 | 54.8 | 65.9 | 72.2 | 75.3 | 79.2 | 8.2 |
| Example 21 | 19.6 | 47.5 | 58.2 | 66.5 | 71.0 | 73.4 | 76.4 | 6.5 |

TABLE 8
Decrease in WOC for Stretched Coiled Webs

| | Decrease in | Percent Decrease |
|---|---|---|
| Example | WOC (kJ/m³) | in WOC |
| Example 11 | 4.3 | 42% |
| Example 12 | 2.1 | 21% |
| Example 13 | 4.6 | 45% |
| Example 15 | 3.9 | 51% |
| Example 17 | 4.5 | 47% |
| Example 18 | 3.5 | 36% |
| Example 19 | 3.7 | 39% |
| Example 20 | 1.4 | 15% |
| Example 21 | 3.1 | 32% |

### Vertical Wicking

A shallow aluminum tray was filled with saline solution (0.9% NaCl in water) to a depth of 12.7 mm. To enhance visualization, the saline solution was dyed with red food coloring. Test samples of Examples 3 and 17 and Comparative Examples A1-A3 were prepared as 25.4 mm by 152.4 mm strips. Comparative Example A1 was the acquisition distribution layer (ADL) obtained from a size six baby diaper commercially available from the Kimberly Clark Corporation, Neenah, Wis., under the trade designation “HUGGIES LITTLE MOVERS”. The ADL was a 3 mm thick nonwoven web having an average basis weight of 106 gsm and an average fiber diameter of 30 microns. Comparative Example A2 was the absorbent core obtained from an adult incontinence pad commercially available from the SCA Personal Products, Philadelphia, Pa., under the trade designation “TENA SERENITY”. The absorbent core was a bonded, air-laid material containing cellulosic fibers and superabsorbent polymer layered between two sheets of tissue. The absorbent core was 5 mm thick and had an average basis weight of 440 gsm. Comparative Example A3 was a “WYPALL L30” nonwoven tissue commercially available from the Kimberly Clark Corporation. A clip was attached to the narrow end of each sample and the samples were individually hung from a support located above the tray. The samples were oriented so that they were positioned perpendicular to the tray and were submerged into the saline solution so that the free ends of the samples touched the bottom of the tray. The samples were maintained in the saline solution for 60 minutes at ambient temperature. The samples were removed from the saline solution and the distance of travel by the saline solution in each sample was measured with a ruler (Table 9). The samples were subsequently drip dried by suspending in air for five minutes and then weighed. The percent weight gain from the fluid held by the web is reported in Table 9.

TABLE 9

| | Distance of Travel by the | Percent |
|---|---|---|
| | Saline Solution (mm) | Weight Gain |
| Example 3 (unstretched) | 0.0 | 1.4% |
| Example 17 (stretched) | 0.0 | 5.9% |
| Comparative Example A1 | 9.5 | 120.8% |
| Comparative Example A2 | 76.2 | 912.2% |
| Comparative Example A3 | 127 | 450.0% |

### Drapability

A rectangular cube with solid horizontal and vertical surfaces was used as the test structure for drapability measurements. A 101.6 mm (CD) by 152.4 mm (MD) sample of the nonwoven web was laid flat on the top surface of the cube and positioned so that 76.4 mm (in MD direction) of the sample hung over the edge. The section of the web sample resting on the horizontal surface was held down by hand pressure. The test structure was large enough to allow the material to hang freely over the edge. Drapability was determined by measuring the shortest distance from the outer edge (of the bottom face) of the overhanging portion of the sample to the adjacent vertical surface of the test structure. The measured results for Examples 3 and 17 are recorded in Table 10.

TABLE 10

| | Measured Distance (mm) |
|---|---|
| Example 3 (unstretched) | 80 |
| Example 17 (stretched) | 25 |

The stretched web increased in drapability by 69% as compared to the unstretched web.

### Hysteresis

The hysteresis properties of the coiled nonwoven webs were measured using a universal constant rate of extension tensile testing instrument equipped with a computer for data recording and the required load ranges was used (Model 5500R available from Instron Engineering Corporation, Canton, Mass.). All testing was conducted at constant temperature (23° C.±2° C.) and relative humidity (50%±5%). All materials and equipment were equilibrated at these conditions for a minimum of 24 hours prior to testing. A 101.6 mm (CD) by 152.4 mm (MD) sample of web was mounted in the Instron instrument so that the sample was held with minimal slack when the jaws of the upper and lower jaws of the instrument were positioned at 76.2 mm apart. Line contact jaws were used to minimize slip and breakage of the sample in the jaws. The instrument crosshead speed was set to 305 mm/minute until a maximum extension of 76.2 mm (100% extension) was achieved. At 100 percent extension, the jaws were held stationary for one second and then returned to the zero extension position of 76.2 mm apart. In Table 11, the load value (in Newtons) measured at web extensions of 25%, 50%, 75%, and 100% are recorded for previously stretched coiled webs (Examples 15 and 19) and previously unstretched coiled webs (Examples 3 and 7). The data shows that previously stretched samples of web had significantly lower load at extensions of 25% when compared to the corresponding previously unstretched sample

TABLE 11
Load (N) at Percent Extension

| | at | At | At | At |
|---|---|---|---|---|
| | 25% | 50% | 75% | 100% |
| Example 3 (unstretched) | 16.6 | 18.9 | 17.4 | 18.9 |
| Example 19 (stretched) | 2.5 (−82%) | 7.7 (−59%) | 14.9 | 18.2 |
| Example 7(unstretched) | 20.9 | 23.3 | 25.4 | 25.6 |
| Example 15 (stretched) | 11.5 (−45%) | 20.7 (−11%) | 26.0 | 28.9 |

### Fluid Transport Rate

The rates of fluid transport by the stretched coiled webs of Examples 12 and 17-20 were measured with and without an applied compression force. A circular sample of the coiled web (75 mm diameter) was placed between two plexiglass plates (20.3 cm by 20.3 cm). A 15 mm diameter hole was cut through the center of the top plate. A glass, conical-shaped funnel (13 mm inner diameter stem) was positioned in the hole so that the bottom of the funnel stem was aligned flush with the bottom of the top plate. A minimum amount of Parafilm™ M (Pechiney Plastic Packaging, Chicago, Ill.) was wrapped around the stem in order to achieve a tight, non-leaking seal between the funnel stem and the hole in the plate. The top plate with attached funnel weighed 427 g. The coiled web sample was positioned so that the hole in the top plate was positioned directly above the center of the coiled web sample. To provide a compression force, individual weights were added to the top plate in a pattern that provided for an even distribution of the total weight (ranging from 0-24 added kilograms) on the top surface. The rate of fluid transport by the coiled webs under different compression forces (0-24 kg) was determined by quickly adding a saline solution (100 mL of 0.9% NaCl in water) to the funnel and measuring the time required for all of the fluid to enter the coiled web. To enhance visualization, the saline solution was dyed with red food coloring. The results for the coiled web samples prepared from Examples 12 and 17-20 are presented in Table 12.

TABLE 12

| | Fluid Transport Rate (seconds) with Weight Added (kg) | | | | | | | |
|---|---|---|---|---|---|---|---|---|
| | 0 | 1 | 4 | 8 | 12 | 16 | 20 | 24 |
| | kg | kg | kg | kg | kg | kg | kg | kg |
| Example 12 | 2 | 2 | 6 | 8 | 8 | 10 | 11 | 12 |
| Example 17 | 2 | 4 | 8 | 11 | 11 | 13 | 15 | 16 |
| Example 18 | 3 | 3 | 6 | 9 | 14 | 12 | 12 | 16 |
| Example 19 | 2 | 3 | 6 | 9 | 10 | 12 | 13 | 13 |
| Example 20 | 2 | 2 | 3 | 5 | 7 | 8 | 8 | 9 |

### Fluid Uptake Rate and Fluid Distribution in Adult Incontinence Pads

The test apparatus and test method described above to measure the fluid transport rate of coiled web samples was used to measure the fluid uptake rates and the fluid distribution of adult incontinence pads that were modified by replacing a section of the absorbent core of the pad with a sample of coiled web. A central portion of the entire thickness of the absorbent core was removed and the coiled web inserted in place of the removed absorbent core, such that one major face of the web was in contact with the topsheet or acquisition-distribution layer (ADL), the opposing major surface of the web was in contact with the backsheet, and the lateral edges corresponding to the thickness of the web were in contact with the absorbent core. Examples of adult incontinence pads used as test articles are well known to those skilled in the art and have been previously described in U.S. Pat. No. 5,019,065 (Scripps), U.S. Pat. No. 6,509,513 (Glaug), U.S. Pat. No. 4,834,735 (Alemany), and U.S. Pat. No. 4,610,678 (Weisman). A typical adult incontinence pad test article was composed of a top sheet; bottom sheet; absorbent core element located between the top and bottom sheets; and an optional ADL located between the absorbent core element and the top sheet. The edges of the top sheet and bottom sheet were attached to form a seal. The overall dimensions of the test pads ranged from about 26-31 cm (length) by 9-11 cm (width) by 3-10 mm (thickness). The overall weight of the test pads ranged from about 11-26 g.

The top sheet was a liquid permeable polypropylene nonwoven having a basis weight of about 27-37 gsm. The back sheet was a liquid impermeable polyethylene film having a thickness of about 0.5-2.0 mil. The absorbent core component was composed of a mixture of cellulosic fibers (about 70-80% by weight) and superabsorbent polymer (about 20-30% by weight). The dimensions of the absorbent core element ranged from about 24-29 cm (length) by 7-9 cm (width) by 3-10 mm (thickness). The amount of absorbent core in the pads ranged from about 8-25 grams. The amount of absorbent core removed to insert the coiled web ranged from about 1.5-3.5 g. In examples of pads with an inserted coiled web component, the pad was reassembled but the opened edge regions were not resealed. The optional ADL was a tissue or nonwoven layer with a basis weight of about 50-150 gsm. The dimensions of the ADL ranged from about 17-31 cm (length) by 4-8 cm (width).

The incontinence pad was positioned in the test apparatus so that the topsheet of the pad faced the upper plate (backsheet resting on the lower plate) and the pad was centered with respect to the hole in the top glass plate. The amount of saline solution used in each test was 75 mL. The rate of fluid uptake by the pad under different compression forces (0-24 kg) was determined by quickly adding the saline solution to the funnel and measuring the time required for all of the fluid to enter the pad. The longitudinal distribution of the liquid in each pad was determined by removing the pad from the apparatus and measuring the total longitudinal distance (mm) traveled by the liquid in the pad. The leakage of liquid from the pads (grams) was measured by initially placing the entire test apparatus in a pan. Any liquid that leaked from the pad during the test was collected in the pan, recovered, and then weighed. The results are presented in Tables 13-17.

### Example 22

A TENA SERENITY adult incontinence pad (available from SCA Personal Products, Philadelphia, Pa.) was modified by removing by hand all of the absorbent core component in a 30 mm by 120 mm section of the pad (centered in both the longitudinal and lateral directions of the pad) and filling the subsequent void with a 1.16 g sample of Example 13. After filling the void, the pad was reassembled by repositioning the original top sheet and acquisition distribution layer (ADL) of the pad. In this configuration, the fluid delivered from the funnel passed through the top sheet and the ADL before flowing into the inserted coiled web (only a negligible amount of fluid contacted the absorbent core without first contacting the coiled web). The coiled web sample of Example 13 was reused for each of the test conditions. Between each test, the web sample was removed from a wet pad, dried by blotting, and then reinserted into the void of a fresh (dry) pad.

### Example 23

A POISE adult incontinence pad (available from Kimberly-Clark Corporation, Neenah, Wis.) was modified using the same procedure as described in Example 22. The void that was created in the pad was filled with a 1.09 g sample of Example 13.

### Example 24

A TENA LADY EXTRA adult incontinence pad (available from SCA Hygeine Products, Stockholm, Sweden) was modified by removing by hand all of the absorbent core component in a 25.4 mm by 140 mm section of the pad (centered in both the longitudinal and lateral directions of the pad) and filling the subsequent void with a 1.22 g sample of Example 15. After filling the void, the pad was reassembled by repositioning the original top sheet and acquisition distribution layer of the pad. In this configuration, the fluid delivered from the funnel passed through the top sheet and the ADL before flowing into the inserted coiled web (only a negligible amount of fluid contacted the absorbent core without first contacting the coiled web). The coiled web sample of Example 15 was reused for each of the test conditions. Between each test, the web sample was removed from a wet pad, dried by blotting, and then reinserted into the void of a fresh (dry) pad.

### Comparative Examples B, C, and D

Comparative Example B was an unmodified TENA SERENITY adult incontinence pad. Comparative Example C was an unmodified POISE adult incontinence pad and Comparative Example D was an unmodified TENA LADY EXTRA adult incontinence pad.

TABLE 13

| | Fluid Uptake Rate (seconds) with Weight Added (kg) | | | | | | | |
|---|---|---|---|---|---|---|---|---|
| | 0 | 1 | 4 | 8 | 12 | 16 | 20 | 24 |
| | kg | kg | kg | kg | kg | kg | kg | kg |
| Example 22 | 2 | 3 | 4 | 12 | 17 | 24 | 33 | 43 |
| Example 23 | 2 | 2 | 4 | 9 | 14 | 19 | 22 | 30 |
| Comparative | 4 | 6 | 23 | 56 | 98 | 117 | 154 | 182 |
| Example B | | | | | | | | |
| Comparative | 2 | 14 | 25 | 53 | 102 | 110 | 133 | 163 |
| Example C | | | | | | | | |

TABLE 14

| | Length of Longitudinal Fluid Distribution | | | | | | | |
|---|---|---|---|---|---|---|---|---|
| | in the Pad (mm) with Weight Added (kg) | | | | | | | |
| | 0 | 1 | 4 | 8 | 12 | 16 | 20 | 24 |
| | kg | kg | kg | kg | kg | kg | kg | kg |
| Example 22 | 140 | 155 | 160 | 169 | 166 | 170 | 173 | 170 |
| Example 23 | 130 | 150 | 142 | 143 | 185 | 175 | 175 | 160 |
| Comparative | 71 | 75 | 85 | 80 | 85 | 85 | 90 | 100 |
| Example B | | | | | | | | |
| Comparative | 73 | 75 | 85 | 83 | 78 | 85 | 82 | 95 |
| Example C | | | | | | | | |

TABLE 15

| | Leakage of Liquid from the Pad | | | | | | | |
|---|---|---|---|---|---|---|---|---|
| | (grams) with Weight Added (kg) | | | | | | | |
| | 0 | 1 | 4 | 8 | 12 | 16 | 20 | 24 |
| | kg | kg | kg | kg | kg | kg | kg | kg |
| Example 22 | 0 | 0 | 0 | 0 | 0 | 0 | 0 | 0 |
| Example 23 | 19.4 | 0.7 | 0 | 0 | 0 | 0 | 0 | 0 |
| Comparative | 9.1 | 0 | 0 | 0 | 0 | 0 | 0 | 0 |
| Example B | | | | | | | | |
| Comparative | 32.2 | 1.4 | 0.4 | 0 | 0 | 0 | 0 | 0 |
| Example C | | | | | | | | |

TABLE 16

Fluid Uptake Rate (seconds)
with Weight Added (kg)

| | 4 kg | 24 kg |
|---|---|---|
| Example 24 | 3 | 32 |
| Comparative Example D | 31 | 102 |

TABLE 17

| | Length of Longitudinal Fluid Distribution | |
|---|---|---|
| | in the Pad (mm) with Weight Added (kg) | |
| | 4 kg | 24 kg |
| Example 24 | 170 | 180 |
| Comparative Example D | 95 | 75 |

### Fluid Uptake Rate and Fluid Distribution in Adult Incontinence Pads Following Multiple Fluid Challenges

Adult incontinence pads constructed according to Example 22 were evaluated for fluid uptake rate and fluid distribution following two 75 mL saline solution challenges. The apparatus described above for determining fluid uptake rate was used. After the first challenge, the added weights and top glass plate were removed and the pad was maintained undisturbed for two minutes. The apparatus was reassembled, and the second saline solution challenge was made. The results are presented in Tables 18-19.

TABLE 18

| | Fluid Uptake Rate (seconds) with Weight Added | | | |
|---|---|---|---|---|
| | (kg) Following Two Saline Solution Challenges | | | |
| | 0 kg | 1 kg | 4 kg | 12 kg |
| Example 22 | 2 | 4 | 8 | 31 |
| Comparative | 23 | 41 | 97 | 262 |
| Example B | | | | |

TABLE 19

Length of Longitudinal Fluid Distribution
in the Pad (mm) with Weight Added (kg)
Following Two Saline Solution Challenges

| | 0 kg | 1 kg | 4 kg | 12 kg |
|---|---|---|---|---|
| Example 22 | 240 | 250 | 270 | 270 |
| Comparative | 160 | 170 | 210 | 265 |
| Example B | | | | |

1. A process of making a nonwoven web comprising the steps of:
providing a first thermoplastic nonwoven web comprising a plurality of coiled filaments wherein the coiled filaments have an average diameter of at least 50 microns and are interengaged with intermittent bonds; and
stretching the web thereby providing a stretched web.

2-34. (canceled)

35. A thermoplastic nonwoven web comprising a plurality of stretched coiled filaments having an average diameter of at least 50 microns interengaged with intermittent bonds.

36. The thermoplastic nonwoven web of claim 35 wherein the stretched coiled filaments are continuous in one direction.

37. The thermoplastic nonwoven web of claim 35 wherein the intermittent bonds comprise melt-bonds.

38. The thermoplastic nonwoven web of claim 35 wherein a face of the nonwoven web comprises at least 1 broken bond per cm².

39. The thermoplastic nonwoven web of claim 35 wherein the stretched web comprises portions of filaments having a smaller diameter than the average diameter, portions of filaments that are oriented, or a combination thereof.

40. The thermoplastic nonwoven web of claim 35 wherein the stretched web has a basis weight ranging from 200 gsm to 400 gsm.

41. The thermoplastic nonwoven web of claim 40 wherein the stretched web has a basis weight ranging from 200 gsm to 300 gsm.

42. The thermoplastic nonwoven web of claim 35 wherein the stretched web has a thickness of 4 to 12 mm.

43. The thermoplastic nonwoven web of claim 35 wherein the web has a density ranging from 0.02 to 0.10 g/cm³.

44. The thermoplastic nonwoven web of claim 43 wherein the web has a density ranging from 0.02 to 0.05 g/cm³.

45. The thermoplastic nonwoven web of claim 35 wherein the web has a work of compression of no greater than 20 kJ/m³.

46. The thermoplastic nonwoven web of claim 45 wherein the web has a work of compression of no greater than 10 kJ/m³.

47. The thermoplastic nonwoven web of claim 35 wherein the nonwoven web can be elongated 25% to 200% in a direction substantially parallel to the direction the filaments are continuous without breaking the intermittent bonds.

48. The thermoplastic nonwoven web of claim 35 wherein the nonwoven web exhibits a load of less than 15 newtons at 25% extension.

49. The thermoplastic nonwoven web of claim 35 wherein the nonwoven web has a drapability of less than 50 mm.

50. The thermoplastic nonwoven web of claim 35 wherein the nonwoven web has exhibits a vertical wicking of saline solution of no greater than 5 mm.

51. (canceled)

52. An assembled intermediate comprising the thermoplastic nonwoven web of claim 1 in combination with another substrate.

53. The assembled intermediate of claim 52 wherein the thermoplastic nonwoven web is proximate an absorbent material.

54. An absorbent article comprising the thermoplastic nonwoven web of claim 35 and an absorbent material proximate the thermoplastic nonwoven web, wherein the article is not a personal hygiene article.
